(19) United States
(12) Patent Application Publication
(10) Pub. No.: US 2016/0034201 A1
(43) Pub. Date: Feb. 4, 2016

(54) MANAGING DE-DUPLICATION USING ESTIMATED BENEFITS

(71) Applicant: International Business Machines Corporation, Armonk, NY (US)

(72) Inventors: David D. Chambliss, Morgan Hill, CA (US); M. Corneliu Constantinescu, San Jose, CA (US); Joseph S. Glider, Palo Alto, CA (US); Danny Harnik, Tel Mond (IL); Maohua Lu, San Jose, CA (US); David P. Woodruff, Mountain View, CA (US)

(73) Assignee: International Business Machines Corporation, Armonk, NY (US)

(21) Appl. No.: 14/450,889

(22) Filed: Aug. 4, 2014

(51) Int. Cl. G06F 3/06; G06F 12/10

(52) U.S. Cl. CPC G06F 3/0608; G06F 3/065; G06F 3/0641; G06F 3/067; G06F 12/1018; G06F 2212/65; G06F 2212/1044

(57) ABSTRACT

A protocol is employed to estimate duplication of data in a storage system. This estimate is employed as a factor of enabling de-duplication, and if de-duplication is enabled, the data sets which will be subject to the de-duplication. The protocol includes a measurement procedure and an execution procedure. The measurement procedure characterizes data duplication in part of the data on the storage system, and the execution procedure use the characterization to adjust selection of which data sets are subject to de-duplication.

### BACKGROUND

The present invention relates to de-duplication of data in a data storage system. More specifically, the invention relates to estimating duplication in the data storage system through use of a tabulation structure, and using the estimate to enable de-duplication of select data sets.

De-duplication reduces the number of data storage devices that need to be used to store a given amount of information. It operates by detecting repetition of identical chunks of data, and in some instances replacing a repeated copy with a reference to another copy of the same content. A de-duplication system also provides for reconstructing the original form of a given piece of content which has been stored in a compressed manner. References are used to locate the original copies of the data so that the full-length form of the desired content can be delivered.

De-duplication involves additional work for the resources on the system. As such, systems employing de-duplication can experience performance issues when applied to large-scale storage systems. When the number of duplicates found is significant, the benefit justifies the extra work, but for some data sets the quantity of duplicates that will be found in a de-duplication system are small enough that operating the de-duplication capability on those data sets is not worth the incremental cost.

### BRIEF SUMMARY

This invention comprises a method, system, and computer program product for estimating a de-duplication benefit, and selectively designating one or more data sets for de-duplication based on the estimated benefit.

A method and computer program product are provided for managing de-duplication of data in a storage system, with the selection of data based on estimated de-duplication benefits. Data-address pairs, each pair consisting of an address and the associated data, are captured from a stream of data, and a content record is generated for each data-address pair in the stream. The content record includes a fingerprint for the data and an address hash for the data address. Each content record is tabulated into a tabulation structure which registers which retained addresses are overwritten. An estimate of a size of addresses referenced by the data-address pairs in the stream and an estimate of a size of distinct non-over-written data in the stream is derived, both from non-overwritten records retained in the structure. The derived estimates are employed to select which data sets in an associated storage system will be subject to de-duplication.

Other features and advantages of this invention will become apparent from the following detailed description of the presently preferred embodiment of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a flow chart depicting an overview of managing de-duplication using estimated benefits.

FIG. 2 is a flow chart illustrating the aspect of capturing and tabulating transactions.

FIG. 3 is a flow chart depicting tabulation processing.

FIGS. 4A and 4B are a flow chart depicting a process for performing a readout on a given monitor group through use of the populated tabulation structure.

FIG. 5 is a flow chart depicting a readout operation performed with reference to the time values retained in the table entries.

FIG. 6 is a flow chart depicting the steps of computing the size vector for missed duplicates.

FIG. 7 depicts a block diagram illustrating tools and components embedded in a computer system to support tabulation processing to support estimated benefits of data de-duplication.

FIG. 8 depicts a block diagram of a computing environment according to an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In a storage system, a stream of data is received and captured. The capture stream includes a list of data sets about which separate de-duplication decisions are identified as potentially useful. The data sets may be in the form of volumes, LUNs, volume groups, storage pools, high-level directories in a file system tree, etc. From the list of data sets, a list of monitor groups is derived for measurement. The number of monitor groups is selected based on system memory and storage resources allocated to the measurement process. The monitor group(s) might include all data sets. However, in one embodiment, some of the data sets may be omitted for a given measurement phase. For each monitor group a tabulation structure is established. The tabulation structure includes a plurality of related tables that are populated from a stream of data-address pairs. In one embodiment, the tables include, but are not limited to, an address to data map table, an address hash set table, and data hash set table. In addition, the tabulation structure includes a written size register with one value for each possible storage format for a data chunk, e.g. compressed and non-compressed.

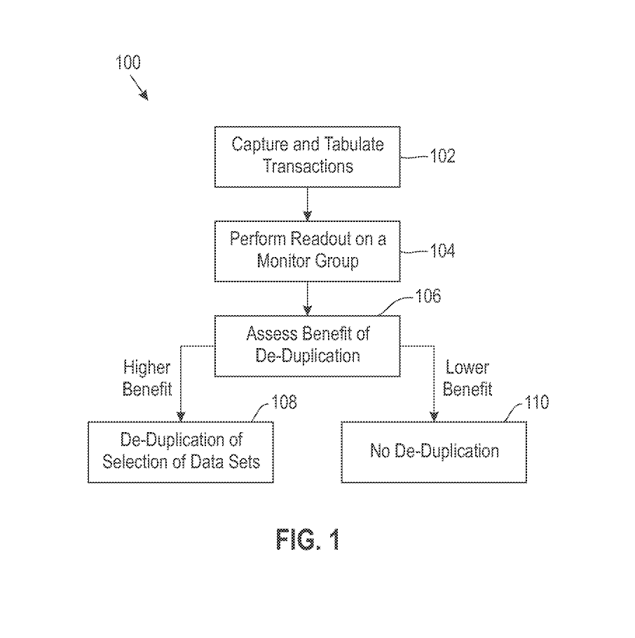

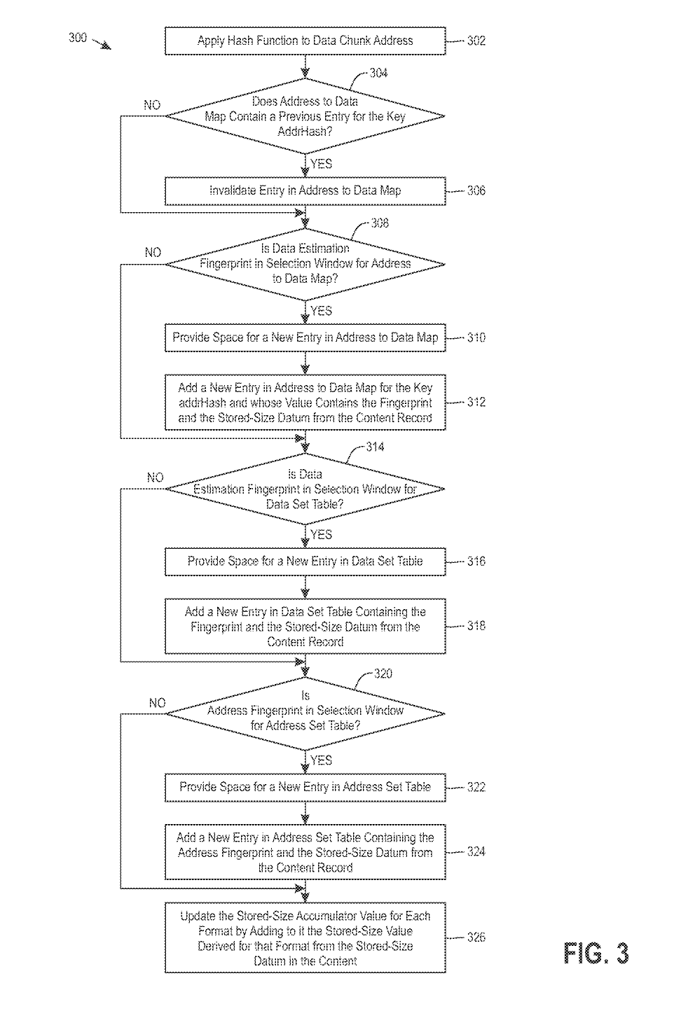

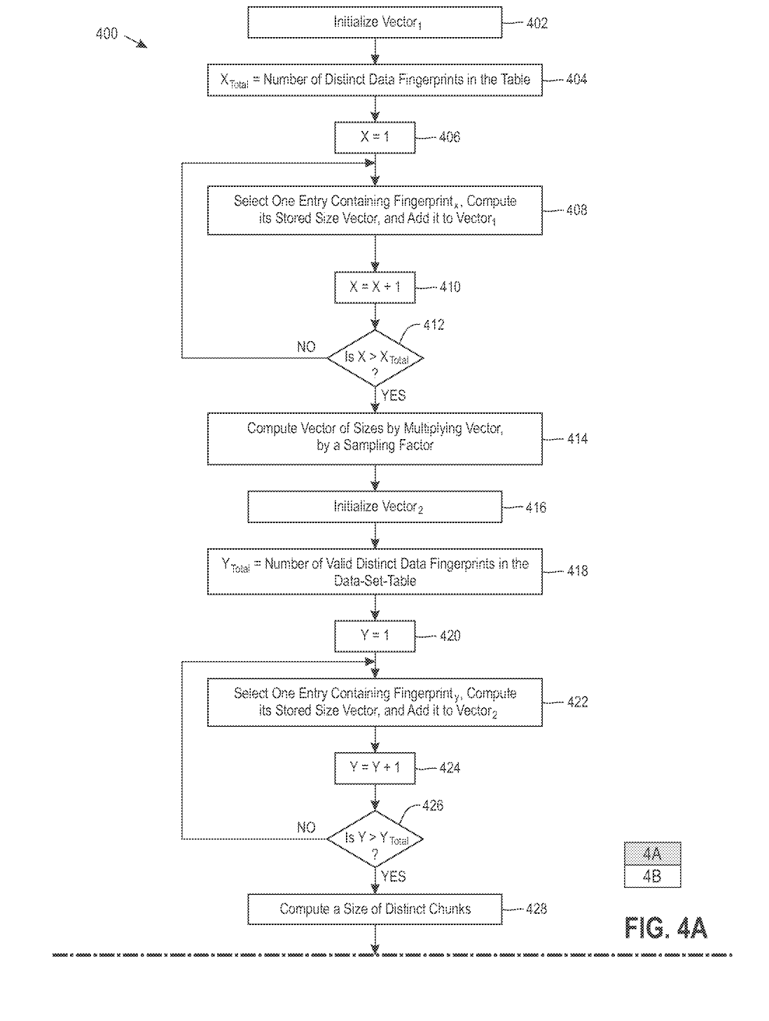

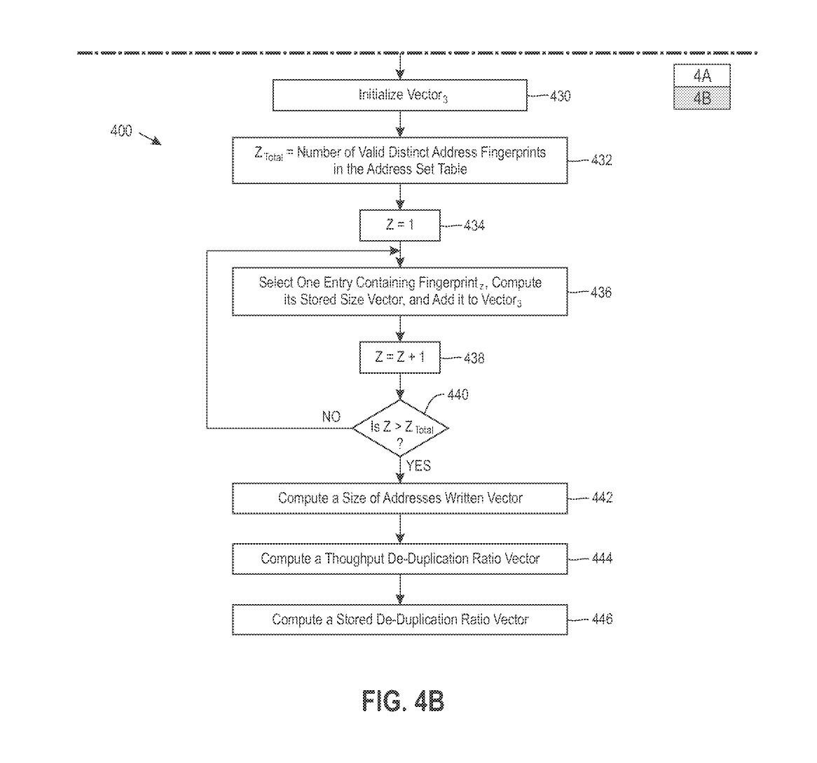

The decision and execution of de-duplication of one or more data sets is based on a derived estimate of the benefits of de-duplication. FIG. 1 is a flow chart (100) depicting an overview of managing de-duplication using the estimated benefits. As shown, the initial step is to capture and tabulate transactions (102), including both read and write transactions. Details of tabulation processing are illustrated and discussed below in FIG. 3. With the use of the multiple tables in the tabulation structure and population of the transactions into the structure, a readout is performed on a monitor group (104). The readout at step (104) provides a measurement on which a decision may be made for application of de-duplication. Following step (104), a determination is conducted to assess the benefit of de-duplication based on an estimated ratio (106). In one embodiment, a ratio with a smaller number yields a higher de-duplication benefit, whereas a ratio with a high number yields a lower de-duplication benefit. Based on the estimate of the benefit reflected in the ratio, de-duplication of a selection of data sets is conducted if there is a higher calculated benefit (108), or not conducted if the calculation yields a lower benefit (110). Details of the computation(s) and estimation(s) are shown and described in FIG. 4. In one embodiment, a selection of data sets in a storage system subject to de-duplication may be adjusted based on the estimated benefit. Accordingly, the tabulation structure in combination with the use of a hash function yields an estimate of benefits of performing de-duplication.

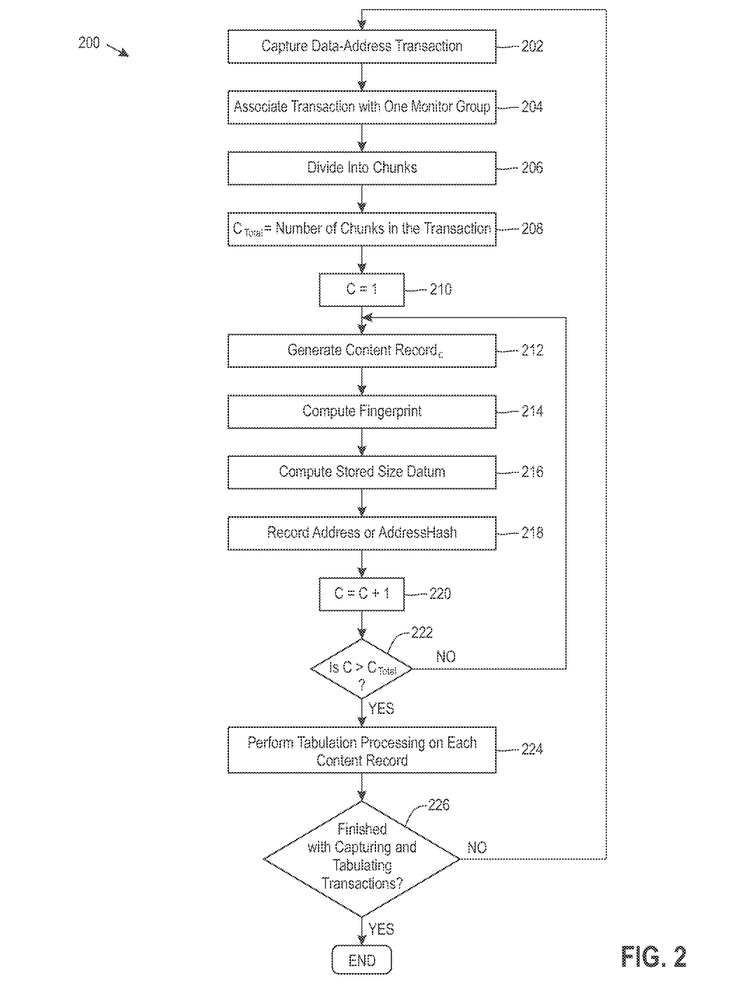

FIG. 2 is a flow chart (200) illustrating the aspect of capturing and tabulating transactions. Each transaction includes one or more read or write operations, or possibly a mixture of both read and write operations. Each read or write operation includes a starting address and a length, and is associated with the data either read from or written to the system starting at the address and extending for the length. From all read or write operations operating against a given data set, some or all are captured for tabulation. The captured operations generate a stream of data-address pairs. The aspect of capturing includes selecting which operations and which data-address pairs to use to generate content records. In one embodiment, the selection of operations includes all write operations to a data set in a given time window, so that overwrites are accurately tracked. Similarly, in one embodiment, incomplete capture of write operations may be allowed by measuring the number of writes not captured and estimating the likely change in the estimation error that results. In one embodiment, substantially all write operations to a data set are captured, meaning all but a controlled and measured small minority of such operations. In addition, all, some, or none of the read operations may be captured, and in addition a stream of scan-reads may be generated for the purpose of being captured to be included in the estimation process. The selection of which operations to capture at what time affects the space of data measured in the estimation process. In one embodiment, results for the stored de-duplication ratio on a data set are not presented or used until a stipulated fraction of the total addresses in the data set has been surveyed by being touched by captured read or write operations. In one embodiment, reads are initially captured and scan-reads are initially generated and captured, and after a stipulated fraction of the total addresses in the data set has been surveyed then the generation and capture of reads is decreased or stopped.

In one embodiment, the aspect of capturing includes a stream of data chunks with their associated addresses. Similarly, in one embodiment, the aspect of capturing may take place while the data is being stored, or it may also include previously stored data. A data-address pair includes the data and the address. In one embodiment, the stream includes data chunks with multiple data-address pairs. In one embodiment, the data-address pairs include substantially all write operations to a region in the storage system. The captured data-address transaction (202) is associated with one monitor group (204) and divided into data chunks (206), hereinafter referred to as chunks. The variable C_{Total} is assigned to the quantity of chunks in the transaction (208), and a chunk counting variable, C, is initialized (210). For each data chunk, a content record, record, is generated (212), which includes a computed data estimation fingerprint (214), a computed stored size datum (216), and an address fingerprint (218). In one embodiment, the content record includes a time value that records the time of the read or write operation. In one embodiment, the address fingerprint is computed with a hash function applied to the address of the data chunk and is also referred to herein as an address hash. In one embodiment, a pre-filter hash is computed while creating the content record, thereby selectively bypassing computation of the data fingerprint. Similarly, in one embodiment, the stored size datum is a value sufficient to derive an estimate of the storage space required to store the data chunk for one or more storage formats. In one embodiment, the storage formats are produced through one or more compression algorithms. In one embodiment, the stored-size datum contains the actual size of the compressed image of the data chunk as provided by one or more compression algorithms. Examples of compression algorithms include, but are not limited to, LZ1, gzip, LZ4, and Huffman coding. Similarly, in one embodiment, the stored-size datum may contain an estimated compression ratio for the chunk under each of one or more compression algorithms.

Following the computation(s) for data chunk, the variable C is incremented (220) and it is determined if a content record has been generated for all of the chunks in the transaction (222). A negative response to the determination at step (222) is followed by a return to step (212), and a positive response to the determination at step (222) is following by performing tabulation processing on each content record (224) using the tabulation structure associated with the monitor group identified in step (204). Details of the tabulation processing are shown and described in FIG. 3. Following step (224), it is determined if the transaction capturing and tabulation is complete (226). In one embodiment, the completion evaluation at step (226) involves determining whether a specified number of hours or days has passed and determining what fraction of a given data set has been sampled by captured data-address pairs. A negative response to the determination at step (226) is followed by a return to step (202), and a positive response concludes the transaction capture and processing.

The data estimation fingerprint computed at step (214) is a value that serves as a representation of the identity of the data. Specifically, the data estimation fingerprint is comparable in use to the data fingerprint that would be calculated if the data were subjected to de-duplication, but may require less computation. In one embodiment, the data estimation fingerprint may be computed through pre-filtering, a hash function, or both. More specifically, the data estimation fingerprint is a fixed size number in the form of a designated value that indicates an invalid fingerprint, or a value computed via a hash function applied to the data in the chunk.

In an embodiment that computes the data estimation fingerprint value using pre-filtering, a pre-filter function is applied to the data, yielding a value that is either true, i.e. accepted, or false, i.e. rejected. The pre-filter function value is determined from the data only, so if the same data is later submitted to the function then the resulting value is ensured to be the same. If the pre-filter value for a given data chunk is false then the fingerprint value for that chunk is the designated invalid fingerprint value and the full hash function is not applied to the data in the chunk. If the pre-filter value for a given data chunk is true then the full hash function is applied to the data in the chunk and the resulting hash value is used as the fingerprint for the chunk. In one embodiment, the pre-filter function is chosen so that randomly generated data would yield a false answer in the majority of cases. The pre-filter function is normally chosen to be significantly less costly in computational resources and time than a full hash function. One way to provide a less costly function is to base the value only on an excerpt containing specific bytes taken from the data, so that bytes omitted from the excerpt need not be examined by the processor and changes in them would cause no change in the result. Another way to reduce the cost is to apply a reduction function, such as a simple exclusive-OR or addition, to the bytes in the content or to an excerpt, and perform any remaining evaluation on a much smaller data size.

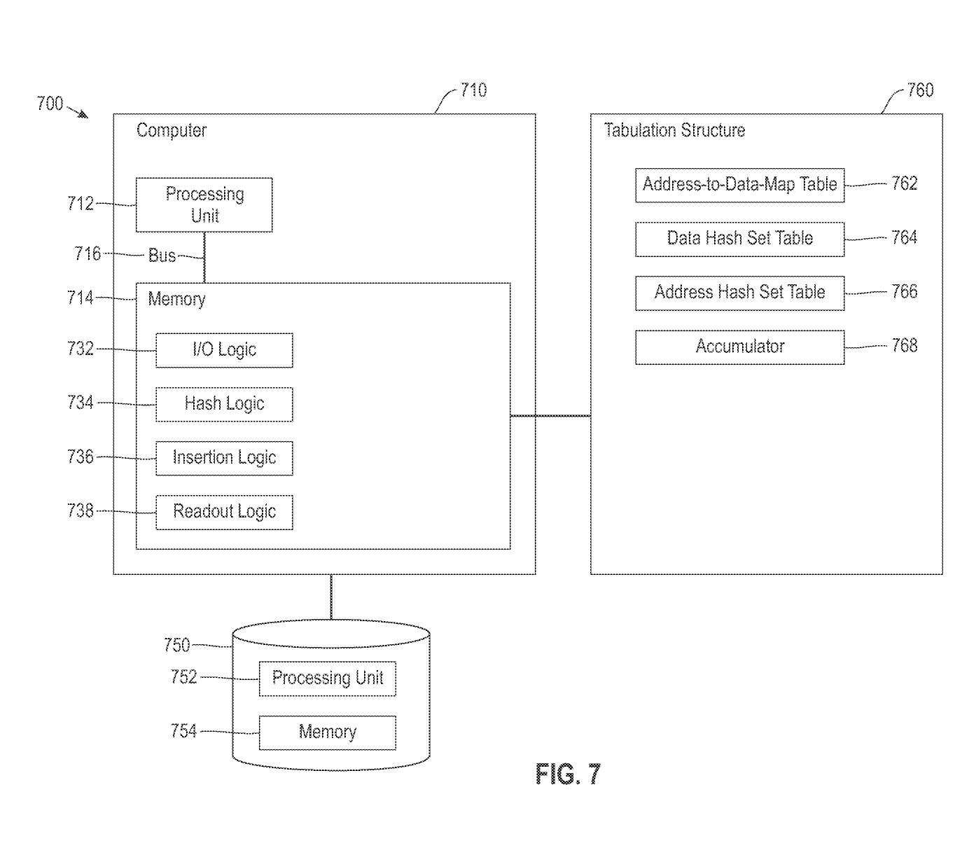

As introduced in FIG. 2, each content record for a given monitor group is processed into a tabulation structure for that group. Details of the tables in the tabulation structure are shown in FIG. 7 described in detail below. FIG. 3 is a flow chart (300) depicting tabulation processing, including populating the tables in the structure. Prior to populating the tables in the tabulation structure, a hash function is applied to the address of the data chunk to convert the address to an address fingerprint (302). In one embodiment, converting the address to a hash value may take place during the processing of data chunks. To ensure that only entries in an associated address to data map that have not been overwritten are processed, a lookup is done in an address to data map using the address fingerprint of the record as a key. It is determined if the address to data map contains a previous entry for the address hash (304). If a previous entry is found, that previous entry is deleted from the map (306). In one embodiment, deletion of an entry from a table may be performed by marking it as invalid and subject to overwrite, without necessarily erasing the binary content from the memory location. Accordingly, the first part of the tabulation processing ensures that entries in the address to data map have not been overwritten.

Following removal of the entry at step (306) or a negative response to the determination at step (304), the data estimation fingerprint of the record subject to tabulation processing is tested against a selection window for the address to data map (308). When the data estimation fingerprint is equal to the designated invalid fingerprint value, that value is not in the selection window. If at step (308) it is determined that the data estimation fingerprint is in the window, then space for a new entry in the address to data map is provided (310), and a new entry is added to the data map. The new entry includes a key in the form of the fingerprint and the value in the form of the stored-size datum from the content record (312). In one embodiment, the entry may also include the time value from the content record. Following step (312) or a negative response to the determination at step (308), it is determined if the data estimation fingerprint is in the selection window for the data set table (314). When the data estimation fingerprint is equal to the designated invalid fingerprint value, that value is not in the selection window.

If at step (314) it is determined that the data estimation fingerprint is in the selection window, space for a new entry is provided in the data set table of the tabulation structure (316), with the new entry containing the fingerprint and the value in the form of the stored-size datum from the content record (318). In one embodiment, the entry may also include the time value from the content record. Following step (318) or a negative response to the determination at step (314), it is determined if the address fingerprint, which is the hash value of the address, is in the selection window for the address set table (320). If the response to the determination at step (320) is positive, space for a new entry is provided in the address set table (322), with the new entry including the address fingerprint and the stored-size datum from the content record (324). In one embodiment, the entry may also include the time value from the content record. Following step (324) or a negative response to the determination at step (320), the stored size accumulator value is updated for each format in the tabulation structure (326). In one embodiment, the update includes adding to the accumulator the stored-size value derived for that format from the stored-size datum in the content record.

In one embodiment the memory allocated to each table in the tabulation structure is of limited size, and the circumstance arises that all the available memory for a table is occupied with valid entries at the time that a step that makes space available, (310) or (316) or (322), is to be performed, and space is made available by adjusting the selection window that applies to that table. Adjusting the selection window comprises making smaller the set of possible fingerprint values that are in the selection window, specifically ensuring that some values in the prior selection window are not in the new window, while ensuring that all values in the new window are in the prior selection window. When the selection window is adjusted, entries in the corresponding table whose selection values (data estimation fingerprint or address fingerprint) are not in the new selection window are deleted. Space occupied by deleted entries is made available for use by new entries.

In one embodiment, when multiple valid entries in the data set table having the same data estimation fingerprint value are present then some of those entries are deleted, leaving at least one valid entry having that data estimation fingerprint. In one embodiment, when multiple valid entries in the address set table having the same address fingerprint value are present then some of those entries are deleted, leaving at least one valid entry having that address fingerprint.

The steps outlined and described in detail in FIG. 3 illustrate a process for populating tables in the tabulation structure. The aspect of populating the tables is shown in one order, although the invention should not be limited to the order shown herein. In one embodiment, the order of populating the tables of the structure may be different than that shown and illustrated herein.

When results are required, the tabulation structure is consulted to yield estimates of total sizes associated with the different collections in the structure. FIGS. 4A and 4B are a flow chart (400) depicting a process for performing a readout on a given monitor group through use of the populated tabulation structure. The readout derives an estimate of a size of distinct surviving data and an estimate of a size of the addresses occupied. Surviving data is data that has not been overwritten, and the obligation of the storage system is to ensure surviving data is stored and available. Distinct data is the set containing one representative copy only for each set of duplicate data chunks. Distinct surviving data is the distinct data in the set of surviving data. The tabulation structure is used to estimate what would be stored in the storage system for different choices about whether and how de-duplication would be performed. As shown and described in detail below, there are several computations that yield a ratio that is indicative of an estimate of the benefit associated with de-duplication and which may be employed for making a de-duplication decision. In one embodiment, the estimate is a measurement of an anticipated de-duplication benefit. A selection of data sets in the storage system that are subject to de-duplication may be adjusted based on the derived estimates.

Initially, a size vector for the address-to-data-map table is computed. In one embodiment, the size vector is known as vector₁. Each table in the structure can have multiple measurements based on different data storage formats, such as a compressed data format and an uncompressed data format. In one embodiment, each vector has the same number of entries being considered. In one embodiment, each vector has a single element representing one format. The aspect of the computation includes, initializing the vector, vector₁ (402), assigning the number of distinct data estimation fingerprints entries in the address-to-data-map table to the variable X_{Total} (404), and initializing a counting variable X for each fingerprint (406). In one embodiment, there might be multiple entries present for a given fingerprint. For a given fingerprint identified by X, a single entry, entry_{X}, is chosen containing that fingerprint. For each chosen entry_{X}, the stored size datum is extracted, and in each of the formats the stored size for a given format is added to the element of the vector, vector₁, corresponding to that format (408). Following step (408), the counting variable X is incremented (410), followed by an assessment to determine if all of the fingerprints have been evaluated (412). A negative response to the determination at step (412) is followed by a return to step (408), and a positive response to the determination at step (412) concludes the processing of the address-to-data-map table.

Following the computation and processing at steps (402)-(412), a vector representing the size of distinct surviving data chunks is assessed. More specifically, a vector of sizes is computed by multiplying the size in table vector for the address-to-data-map table by a sampling factor (414). In one embodiment, the sampling factor is a numerical value representing the ratio of the number of possible fingerprint values and the number of fingerprint values in the selection window for the address to data map table. The vector computed at step (414) is the output from steps (402)-(412) and represents the size of distinct surviving data chunks. Following the computation at step (414), a size-in-table vector is computed for the data set table. The computation includes initializing a size-in-table vector, vector₂, (416). The variable Y_{Total} is assigned to the number of distinct fingerprints contained in valid entries in the data-set table (418), and an associated counting variable Y is initialized (420). In one embodiment, there might be multiple entries present for a given fingerprint. For a given fingerprint identified by Y, a single entry, entry_{Y}, is chosen containing that fingerprint. For each valid entry_{Y}, the stored size for the entry is computed and added into a second size-in-table vector, vector₂, (422) as described for step (408) above. The computation at step (422) computes a size vector or the sizes for all formats. Following the computation at step (422), the counting variable Y is incremented (424). It is then determined if all of the fingerprints in the data set table have been assessed (426). A negative response to the determination at step (426) is followed by a return to step (422), and a positive response to the determination at step (426) concludes the assessment of the valid entries in the data set table. Following a positive response to the determination at step (426), a size of distinct chunks vector is computed (428). In one embodiment, the computation is a product of the size-in-table vector for the data set table, and a sampling factor, with the sampling factor being the ratio of the number of possible fingerprint values to the number of fingerprint values in the selection window for the data-set table.

Following the computation at step (428), a size-in-table vector is computed for the address set table. More specifically, the computation includes initializing a size-in-table vector, vector₃, (430), assigning the variable Z_{Total} to the number of distinct address fingerprints contained in valid entries in the address set table (432), and initializing an associated counting variable Z (434). In one embodiment, there might be multiple entries present for a given address fingerprint. For a given address fingerprint identified by Z, a single entry entry_{z} is chosen containing that fingerprint. For each chosen entry_{z} , the stored sizes for the entry are computed and added into the vector, vector₃, (436). Following the computation at step (436), the counting variable Z is incremented (438). It is then determined if all of the entries in the address set table have been assessed (440). A negative response to the determination at step (440) is followed by a return to step (436), and a positive response to the determination at step (440) concludes the assessment of the valid entries in the address set table. Using the computed size-in-table vector, a size of addresses written vector is computed (442). In one embodiment, the computation at step (442) is a product of the size-in-table vector for the addresses set table and a ratio of the number of possible address hash values to the number of address hash values in the selection window for the address set table.

Following the computation at step (442), a throughput de-duplication ratio vector is computed (44). In one embodiment, the computation at step (444) includes dividing the size of distinct chunks vector by the stored size accumulator vector on an element by element basis. More specifically, the throughput de-duplication ratio for a given format is the size of distinct chunks for that format divided by the stored raw size for that element. Following step (444), a stored de-duplication ratio vector is computed (446) as an indicator of a de-duplication benefit. In one embodiment, the computation at step (446) includes dividing the size of distinct surviving chunks vector by the size of addresses written vector on an element by element basis. The stored de-duplication ratio for a given format is the size of distinct surviving chunks for that format divided by the size of addresses written for that element. Accordingly, the ratio assessed at step (442) is an indicator of the approximate benefits associated with de-duplication.

The processing shown in FIGS. 1-4 is for a given monitor group. In one embodiment, the processing may be applied to multiple monitor groups. More specifically, in the case of multiple monitor groups, the estimation and results of de-duplication may be applied to a union of monitor groups, such that the estimate may reflect a cross-duplication between monitor groups. In one embodiment, the cross-duplication assessment is conducted by merging corresponding maps and selection windows from all monitor groups in the identified or selected union. The selection windows are merged by choosing an intersection of the windows. In one embodiment, the chosen intersection is the narrowest window in the group or the lowest threshold. All entries from the collection of maps to be merged are assessed. Any entries that do not fulfill the selection criterion of the merged selection window are discarded, and the distinct entries are retained as the merged map from which the size-in-map and size-in-population values are derived for estimation and processing.

The following is an example illustrating content that is present in the estimates. In this example, the stream of data includes the following write operations in the following order:
write data_{R} at address_{A}
write data_{R} at address₁
write data_{S} at address_{C}
write data_{X} at address_{A}
write data_{S} at address_{A}
write data_{X} at address_{A}
write data_{Y} at address_{B}
write data_{Y} at address_{C}
   Surviving data is referred to data that has not been overwritten during the write operations. In this example, the surviving data is data_{X} at address_{A}, data_{Y} at address_{B}, and data_{Y} at address_{C}. The size of the addresses is three identified as set {a, b, c}, and the distinct data that has survived has a size of two, data_{X} and data_{Y}, also referred to as data set {x, y}. The space benefit of de-duplication is expressed as a ratio of the distinct surviving data size to the surviving address size. In this example, there is stored de-duplication ratio 2:3 meaning that one-third of the space is saved if the data is subject to de-duplication. All data in the data stream in the order written is identified as the set {R, R, S, X, S, X, Y, Y} with a size of eight, and all distinct data in the data stream is identified as {R, S, X, Y} with a size of four. The throughput benefit of de-duplication is expressed as the ratio derived from distinct data in the stream and data in the stream. In this example, the throughput de-duplication ratio is 4:8 meaning that half of the write volume is avoided if the data is subject to de-duplication.

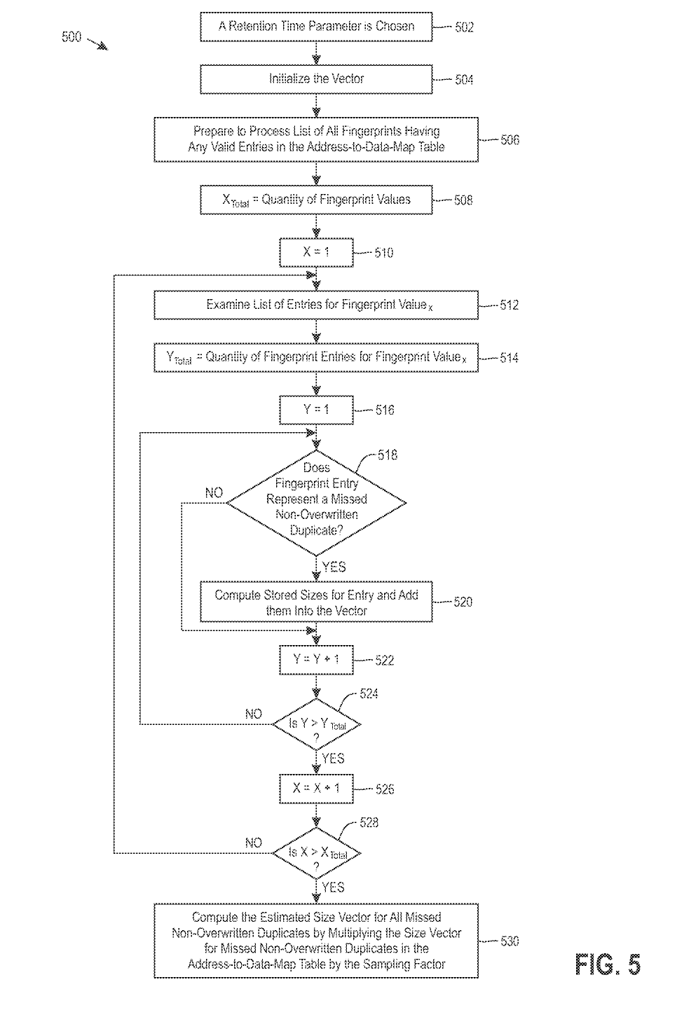

In an embodiment, an additional readout operation may be performed with reference to the time values retained in the table entries. The additional readout operation is shown and described in FIG. 5, and provides estimates of the size of missed duplicates and the size of missed non-overwritten duplicates, either as one value associated with a de-duplication directory size parameter, or as a vector of values associated with a vector of de-duplication directory size parameters. A de-duplication directory size parameter expresses how much of the history of previously seen chunks is retained in the de-duplication system for which estimates are being made. The parameter may be expressed in units of memory size (such as megabytes) or in units of time (such as hours).

To perform the additional readout operation for one de-duplication directory size parameter, first a retention time parameter is chosen (502) and then a size vector for missed non-overwritten duplicates in the address to data map table is computed. The computation starts with initialization of the vector (504). Thereafter, preparation to process the list of all fingerprints having any valid entries in the address-to-data-map table is initiated (506). A variable X_{Total} is assigned to the quantity of fingerprint values (508), and an associated counting variable X is initialized (510). For each fingerprint value_{X}, a list of all entries from the address to data map table containing that fingerprint is examined (512). A quantity of fingerprint entries is assigned to the variable Y_{Total} (514) and an associated counting variable Y is initialized (516). The list is examined with reference to the order of the time values of entries in the list, so that an entry can be compared with the previous entry, i.e., the entry in the list with the next lowest time value, if there is such an entry. For each fingerprint entry_{Y} it is determined if it represents a missed non-overwritten duplicate (518). An entry represents a missed non-overwritten duplicate if its time value is greater than the time value of the previous entry in the list by more than the retention time parameter selected at step (502). In one embodiment, the list of entries is examined in increasing order of the time values in the entries. For the first entry in the list of entries, also referred to herein as the earliest entry, having the same fingerprint value there is no previous entry and the first entry does not represent a missed non-overwritten duplicate.

If the evaluation step (518) yields a positive result then the method proceeds with computing the stored sizes for the entry and adding them into the vector (520). Following step (520) or a negative result from the determination (518), the counting variable Y is incremented (522), and it is determined if all of the fingerprint entries for fingerprint value_{X} have been evaluated (524). A negative response to the determination at step (524) is followed by a return to step (518). Conversely, a positive response to the determination at step (524) is followed by an increment of the counting variable X associated with the quantity of fingerprint values (526). It is then determined if all of the fingerprint values X have been assessed (528). A negative response to the determination at step (528) is followed by a return to step (512). After all fingerprint values in the address to data map table have been examined, as shown herein as a positive response to the determination at step (528), the size vector for missed non-overwritten duplicates in the address to data map table is complete. Then the estimated size vector for all missed non-overwritten duplicates is computed by multiplying the size vector for missed non-overwritten duplicates in the address to data map table by the sampling factor computed in FIG. 4 (530).

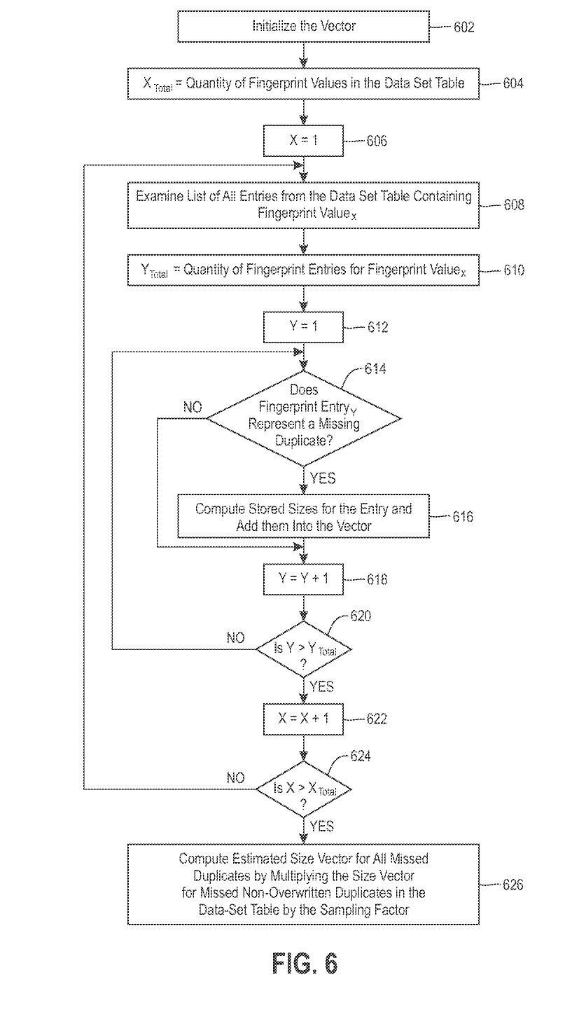

Following the readout in FIG. 5, a size vector for missed duplicates in the data set table is computed. FIG. 6 is a flow chart (600) illustrating the steps of computing the size vector for missed duplicates. The aspect of the computation includes, initializing the vector (602), and preparing to process a list of all distinct fingerprint values in the data set table. Specifically, the variable X_{Total} is assigned to the quantity of fingerprint values in the data set table (604), and an associated counting variable is initialized (606). For each fingerprint value, a list of all entries from the data set table containing that fingerprint is examined (608). The list is examined with reference to the order of the time values of entries in the list, so that an entry can be compared with the previous entry, i.e., the entry in the list with the next lowest time value, if there is such an entry. The variable Y_{Total} is assigned to the quantity of fingerprint entries for fingerprint value_{X} (610), and an associated fingerprint entry counting variable Y is initialized (612). It is then determined if fingerprint entry_{Y} represents a missed duplicate (614). For the earliest entry in the list of entries having the same fingerprint value there is no previous entry and the first entry does not represent a missed duplicate. If the evaluation step (614) yields a positive result then the method proceeds with computing the stored sizes for the entry and adding them into the vector (616).

Following step (616) or a negative result from the determination at (614) the next entry in the list of entries having the same fingerprint value is examined (618), and it is determined if there are any more entries in the list that have not been examined (620). If there are more entries having the same fingerprint value, then the evaluation step (614) is performed on the next entry. If there are no more entries having the same fingerprint value, the counting variable X associated with the fingerprint values is incremented (622), and it is determined if all of the fingerprint values X have been processed (624). A negative response to the determination at step (624) is following by a return to step (608). After all fingerprint values in the data set table have been examined, the size vector for missed duplicates in the set table is complete. Then the estimated size vector for all missed duplicates is computed (626) by multiplying the size vector for missed non-overwritten duplicates in the data set table by the sampling factor computed in FIG. 4.

Following the evaluation of the estimated size vector for all missed non-overwritten duplicates and the estimated size vector for all missed duplicates in association with the retention time parameter, the retention time parameter is associated with a de-duplication directory size parameter. A de-duplication directory size parameter in units of time may be associated with a specified retention time parameter by setting them equal. A de-duplication directory size parameter in units of memory space may be associated with a specified retention time parameter by multiplying the retention time parameter by the rate of content ingestion in megabytes per second, and multiplying the product by the size of a directory entry divided by the size of a chunk represented by one directory entry. Alternatively, a retention time parameter may be computed from a specified de-duplication directory size parameter in units of memory space by dividing by the same factor.

To perform the additional readout operation for a vector of de-duplication directory size parameters, the method performs the steps of FIG. 5 and FIG. 6 for each de-duplication directory size parameter value contained in the vector.

The following is an example illustrating content that is present in the estimates. In this example, the stream of data includes the following write operations in the following order at the specified times:
write data_{R} at address_{A} at time 01:00
write data_{R} at address_{B} at time 01:30
write data_{S} at address _{C} at time 02:00
write data_{X} at address_{A} at time 02:01
write data_{S} at address_{A} at time 02:45
write data_{X} at address_{A} at time 03:30
write data_{Y} at address_{B} at time 04:00
write data_{Y} at address _{C} at time 06:00
   Surviving data is referred to data that has not been overwritten during the write operations. In this example, the surviving data is data_{X} at address_{A}, data_{Y} at address_{B}, and data_{Y} at address. The size of the addresses is three identified as set {a, b, c}, and the distinct data that has survived has a size of two, data_{X} and data_{Y}, also referred to as data set {x, y}. The space benefit of de-duplication is expressed as a ratio of the distinct surviving data size to the surviving address size. In this example, there is stored de-duplication ratio 2:3 meaning that one-third of the space is saved if the data is subject to de-duplication. All data in the data stream in the order written is identified as the set {R, R, S, X, S, X, Y, Y} with a size of eight, and all distinct data in the data stream is identified as {R, S, X, Y} with a size of four. The throughput benefit of de-duplication is expressed as the ratio derived from distinct data in the stream and data in the stream. In this example, the throughput de-duplication ratio is 4:8 meaning that half of the write volume is avoided if the data is subject to de-duplication.

In the example, the address to table map contains entries [(data X at A, time 03:30, size 1), (data Y at B, 04:00), (data X at C, 06:00, size 1)}. If a retention time parameter of 1 hour or 01:00 has been chosen, then the procedure of FIG. 5 addresses the two fingerprint values {X,Y} having entries in the address to data map table. There is only one entry for data X so there is no missed non-overwritten duplicate with fingerprint X. The entry for data Y at B is the first in the list for data Y and is not a missed non-overwritten duplicate. The entry for data Y at C is a missed non-overwritten duplicate because its time value 06:00 is greater than the time of the previous entry, 04:00, by two hours which is more than the retention time parameter of 1 hour. The entry has size 1 so the total size of missed non-overwritten duplicates in the table is 1. In assessing the benefit of de-duplication on the volume of data held in storage, the user would see that a system without any de-duplication would need to hold data in storage for each address {A, B, C} with a size of three, a system with ideal de-duplication would need to hold data in storage for only the distinct non-overwritten data {X, Y} with a size of two, and a system with de-duplication limited by the retention time parameter of 1 hour would need to hold data in storage for the distinct non-overwritten data plus the missed non-overwritten duplicates {X,Y,Y} with a size of 3. In this example the user may note that the missed non-overwritten duplicates would negate any de-duplication benefit for the size of stored data and might further determine that a larger retention time parameter should be selected.

In the example, the data set table would contain the values {(R at 01:00), (R at 01:30), (S at 02:00), (X at 02:01), (S at 02:45), (X at 03:30), (Y at 04:00), (Y at 06:00)}, all with size datum values yielding size 1. The procedure of FIG. 6 would address the lists for fingerprints of data values {R, S, X, Y}. For data R there is no missed duplicate because the time difference between 01:30 and 01:00 is less than the retention time parameter of 1 hour. For data S there is no missed duplicate because the time difference between 02:45 and 02:00 is less than the retention time parameter of 1 hour. For data X there is one missed duplicate because the time difference between 03:30 and 02:01 is greater than the retention time parameter of 1 hour. For data Y there is one missed duplicate because the time difference between 06:00 and 04:00 is greater than the retention time parameter of 1 hour. If these operations had been applied to a de-duplicating storage system whose fingerprint retention time for duplicate detection is uniformly 1 hour, then the fingerprint for data X inserted at 02:01 would have been removed from the detection directory prior to 03:30 and so the operation at 03:30 of writing X to address A would not have been detected as a duplicate. Likewise the operation at 06:00 of writing Y to address C would not have been detected as a duplicate. The total size of missed duplicates is 2. In assessing the benefit of de-duplication on the volume of data written, the user would see that a system without any de-duplication would have written the data {R, R, S, X, S, X, Y, Y} with a size of eight, a system with ideal de-duplication would have written only the distinct data {R,S, X, Y} with a size of four, and a system with de-duplication limited by the retention time parameter of 1 hour would have written the distinct data and the missed duplicates {R, S, X, X, Y, Y} with a size of 6.

Following the processing shown in FIGS. 5 and 6, the method provides for examining the results of the additional readout operation and using the results to select the de-duplication directory size parameter value to be used in the de-duplication operations for the given dataset. For example, when a small value of directory size is associated with a large estimated size of missed duplicates, the choice may be to use a larger value of directory size in the operations, so as to avoid missing the duplicates. When a small value of directory size is associated with a small estimated size of missed duplicates, the choice may be to use a smaller value of directory size in the operations, so as to reduce memory usage and use memory for other purposes that yield greater benefit.

The methods described in FIGS. 1-4 provide advantages with estimating de-duplication benefit. One advantage is that by capturing substantially all writes to the volume and registering which retained addresses are overwritten, the a readout of benefit estimates at any point in time is enabled without any need to re-read data from its storage medium and re-compute fingerprints. Another advantage is that estimates of duplication in all areas recently written is obtained without needing to perform any additional generated reads, e.g. a scan of cold data. An even further advantage is that the present embodiments are applicable in systems that do not provide any log of changed addresses. Another advantage is that the methods use less computational resources than existing art by use of a pre-filter function. Yet another advantage is that the methods supply measurements of the benefit of de-duplication when combined with one or more compression techniques or alternative storage formats, and the methods provide an estimate of the throughput reduction from de-duplication.

The processes shown in FIGS. 1-4 may be embodied as hardware components. FIG. 7 is a block diagram (700) illustrating tools and components embedded in a computer system to support tabulation processing to support estimated benefits of data de-duplication. As shown, the system includes a computer (710) in communication with data storage (750). The computer (710) is provided with a processing unit (712) in communication with memory (714) across a bus (716). The data storage (750) supports data de-duplication. The data storage (750) is provided with a processing unit (752) in communication with memory (754). In one embodiment, the data storage (750) may be remote with access to the storage provided across a network.

The computer (710) includes one or more tools to support the functionality with respect to data de-duplication. The tools include, but are not limited to, I/O logic (732), profile and hash logic (734), insertion logic (736), readout logic (738), and a tabulation structure (760). The I/O logic (732) takes data and generates an additional action based on whether the data is associated with a read transaction or a write transaction. All read and write data is subject to the pre-filter and hash logic (734) which divides the data into chunks, and for each chunk computes a hash on both the data and the data address. For each pair of data and a data address, the insertion logic tabulates the data and associated address into the tabulation structure.

As shown, the computer (710) is shown with having at least four related tables therein that are configured to be populated from a data stream, and further employed to perform de-duplication processing. More specifically, the tables include an address-to-data map table (762), a data hash set table (764), an address hash set table (766), and an accumulator (768). In one embodiment, the structure (760) may include additional tables, and as such should not be limited to the quantity shown and described herein. As a data stream is processed, each of the tables (762)-(768) is populated with data from the data stream. More specifically, for each data chunk in the stream the following is computed and stored in the tables: a data estimation fingerprint, a computed stored size datum, and an address fingerprint for the subject data stream. In one embodiment, the address fingerprint is computed with a hash function applied to the address of the data chunk, also referred to herein as an address hash. Similarly, in one embodiment, the stored size datum is a value sufficient to derive an estimate of the storage space required to store the data chunk. The computed data estimation is an estimate of a size of surviving data, which includes data remaining after tabulation processing and an estimate of a size of addresses occupied.

The readout logic (738) is in communication with the structure (760) and derives estimates from which de-duplication decision may be made. The readout logic (738) provides the following information: total size of data, total footprint of data, total size of distinct data, and total size of distinct surviving data. A selection of data sets in an associated storage system subject to de-duplication may be adjusted using the derived estimates. Significant processing is required to calculate a computer data fingerprint used to find duplicate data. Identifying and recording duplications consumes performance resources. The functionality of the logic (732)-(738) provides an accurate estimate of duplication in the data of a storage system, and furthermore, uses the estimate to select whether to enable de-duplication, and if so, the data sets subject to the de-duplication. In order to maintain the tabulation structure (760) at a manageable size, the structure may be maintained below a fixed bound. More specifically, content records may be selectively retained according to the hash values of data and addresses. In one embodiment, one or more vectors are employed to facilitate estimation of de-duplication. More specifically, the estimate of the size of surviving data and the estimate of the size of addresses occupied may be organized into a vector. Each vector contains at least two measurements based on different formats for storing data, including a compressed data format and a non-compressed data format. Similarly, each vector has the same quantity of entries.

As discussed above with respect to FIG. 2, for each read and write operation, a stream of data-address pairs is captured and content records are generated. The I/O logic (732) functions to generate the content records, which in one embodiment includes a stored-size datum. Similarly, in one embodiment, the readout logic (736) employs the stored-size datum to derive an estimate of storage space.

The tools shown herein employ the processing unit(s) to support their computations for data de-duplication. As described above in FIGS. 1-7, computations are performed in the form of estimated benefits for data de-duplication. As identified above, the logics (732)-(738) are shown residing in memory (714) of the computer (710). In one embodiment, the logics (732)-(738) may individually or collectively reside as hardware tools external to the memory (714). In another embodiment, the logics (732)-(738) may be implemented as a combination of hardware and software in a shared pool of resources. Similarly, in one embodiment, the logics (732)-(738) may be combined into a single functional item that incorporates the functionality of the separate items. As shown herein, each of the logics (732)-(738) are shown local to one computer system (710). However, in one embodiment they may be collectively or individually distributed across a shared pool of configurable computer resources and function as a unit to support estimation for data de-duplication. Similarly, the tabulation structure (760) including tables (762)-(768), are shown residing outside of memory (714). In one embodiment, the tabulation structure (760) including tables (762)-(768) may reside in memory (714). Accordingly, the tools may be implemented as software tools, hardware tools, or a combination of software and hardware tools.

Furthermore, the described features, structures, or characteristics may be combined in any suitable manner in one or more embodiments. Examples of the managers have been provided to lend a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The functional unit described above in FIG. 7 has been labeled with tools. The tools may be implemented in programmable hardware devices such as field programmable gate arrays, programmable array logic, programmable logic devices, or the like. The tool may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of managers, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

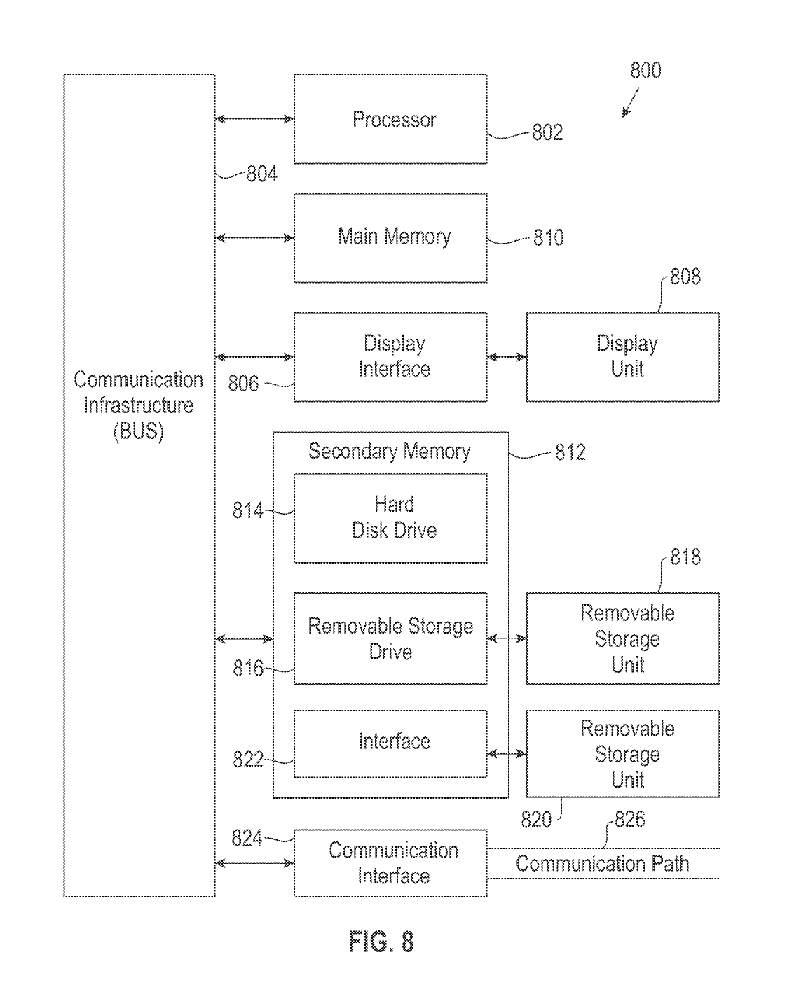

Referring now to the block diagram of FIG. 8, additional details are now described with respect to implementing an embodiment of the present invention. The computer system includes one or more processors, such as a processor (802). The processor (802) is connected to a communication infrastructure (804) (e.g., a communications bus, cross-over bar, or network).

The computer system can include a display interface (806) that forwards graphics, text, and other data from the communication infrastructure (804) (or from a frame buffer not shown) for display on a display unit (808). The computer system also includes a main memory (810), preferably random access memory (RAM), and may also include a secondary memory (812). The secondary memory (812) may include, for example, a hard disk drive (814) and/or a removable storage drive (816), representing, for example, a floppy disk drive, a magnetic tape drive, or an optical disk drive. The removable storage drive (816) reads from and/or writes to a removable storage unit (818) in a manner well known to those having ordinary skill in the art. Removable storage unit (818) represents, for example, a floppy disk, a compact disc, a magnetic tape, or an optical disk, etc., which is read by and written to by removable storage drive (816). As will be appreciated, the removable storage unit (818) includes a computer readable medium having stored therein computer software and/or data.

In alternative embodiments, the secondary memory (812) may include other similar means for allowing computer programs or other instructions to be loaded into the computer system. Such means may include, for example, a removable storage unit (820) and an interface (822). Examples of such means may include a program package and package interface (such as that found in video game devices), a removable memory chip (such as an EPROM, or PROM) and associated socket, and other removable storage units (820) and interfaces (822) which allow software and data to be transferred from the removable storage unit (820) to the computer system.

The computer system may also include a communications interface (824). Communications interface (824) allows software and data to be transferred between the computer system and external devices. Examples of communications interface (824) may include a modem, a network interface (such as an Ethernet card), a communications port, or a PCMCIA slot and card, etc. Software and data transferred via communications interface (824) is in the form of signals which may be, for example, electronic, electromagnetic, optical, or other signals capable of being received by communications interface (824). These signals are provided to communications interface (824) via a communications path (i.e., channel) (826). This communications path (826) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (810) and secondary memory (812), removable storage drive (816), and a hard disk installed in hard disk drive (814).

Computer programs (also called computer control logic) are stored in main memory (810) and/or secondary memory (812). Computer programs may also be received via a communication interface (824). Such computer programs, when run, enable the computer system to perform the features of the present invention as discussed herein. In particular, the computer programs, when run, enable the processor (802) to perform the features of the computer system. Accordingly, such computer programs represent controllers of the computer system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the code stream compression supports flexibility with respect to decompression, including, decompression of the code stream from an arbitrary position therein, with the decompression being a recursive process to the underlying literal of a referenced phrase.

### Alternative Embodiment

It will be appreciated that, although specific embodiments of the invention have been described herein for purposes of illustration, various modifications may be made without departing from the spirit and scope of the invention. In particular, the migration may occur dynamically and/or concurrently with I/O operations and de-duplication processing. Accordingly, the scope of protection of this invention is limited only by the following claims and their equivalents.

We claim:

1. A method comprising:
capturing data-address pairs from an operation, the operation selected from the group consisting of: a read operation externally received by a storage system, a write operation externally received by the storage system, a read operation internal to the storage system, a write operation internal to the storage system, and combinations thereof, and the captured pair including data associated with the operation and an associated data address;
generating a content record for each data-address pair in the stream, the content record including a data fingerprint and an address hash;
tabulating each generated content record into a tabulation structure, the tabulating registering which retained addresses are overwritten;
from non-overwritten records retained in the structure, deriving an estimate of a size of addresses referenced by the data-address pairs in the stream, and deriving an estimate of a size of distinct non-overwritten data in the stream; and
using the derived estimates, selecting which data sets in an associated storage system will be subject to de-duplication.

2. The method of claim 1, further comprising maintaining a size of the structure below a fixed bound by selectively retaining content records according to hash value of data and addresses.

3. The method of claim 2, wherein the data-address pairs include substantially all write operations to a region in the storage system.

4. The method of claim 3, further comprising computing a pre-filter hash while creating the content record, and selectively bypassing computation of the fingerprint based on a result on the pre-filter hash.

5. The method of claim 1, wherein the generated content record includes a stored-size datum, and further comprising deriving an estimate of storage space from the stored-size datum.

6. The method of claim 5, wherein the derived estimate of the size of non-overwritten data and the estimate of the size of addresses occupied further constituting vectors, each vector containing two or more measurements based on different formats for storing data, and each vector having a same quantity of entries.

7. The method of claim 1, further comprising deriving from the structure an estimate of a size of all data in the stream, and an estimate of a size of all distinct data in the stream.

8. The method of claim 1, further comprising deriving an estimate of a size of missed non-overwritten duplicates associated with a de-duplication directory size parameter.

9. The method of claim 8, further comprising deriving a vector of estimates of the size of missed non-overwritten duplicates associated with a vector of de-duplication directory size parameters.

10. The method of claim 8, further comprising deriving an estimate of the size of missed duplicates associated with a de-duplication directory size parameter.

11. The method of claim 8, wherein the generated content record includes a time value.

12. A computer program product for managing de-duplication, the computer program product comprising a computer readable program storage device having program code embodied therewith, the program code executable by a processor to:
capture a stream of data-address pairs;
generate a content record for each data-address pair in the stream, the content record including a data fingerprint and an address hash;
tabulate each generated content record into a tabulation structure, the structure registering which retained addresses are overwritten;
from non-overwritten records retained in the structure, code to derive an estimate of a size of addresses referenced by the data-address pairs in the stream, and derive an estimate of a size of distinct non-overwritten data in the stream; and
using the derived estimates, code to select which data sets in an associated storage system will be subject to de-duplication.

13. The computer program product of claim 12, further comprising program code to maintain a size of the structure below a fixed bound by selective retention of content records according to a hash value of data and addresses.

14. The computer program product of claim 13 wherein the data-address pairs include all write operations to a region in the storage system.

15. The computer program product of claim 12, wherein the generated content record includes a stored-size datum, and further comprising code to derive an estimate of storage space from the stored-size datum.

16. The computer program product of claim 12, further comprising code to derive from the structure an estimate of a size of all data in the stream, and an estimate of all distinct data in the stream.

17. The computer program product of claim 12, further comprising code to derive an estimate of a size of missed non-overwritten duplicates associated with a de-duplication directory size parameter.

18. The computer program product of claim 17, further comprising code to derive a vector of estimates of the size of missed non-overwritten duplicates associated with a vector of de-duplication directory size parameters.

19. The computer program product of claim 17, further comprising code to derive an estimate of the size of missed duplicates associated with a de-duplication directory size parameter.

20. A method comprising:
capturing a stream of data, including identifying units of data and an associated data address for each unit;
generating a content record for each pair of data and the associated data address in the stream;
tabulating each generated content record into a tabulation structure and registering retained addresses that have been overwritten;
from the content record tabulation, deriving an estimate of a size of addresses referenced by the data-address pairs in the stream and deriving an estimate of a size of addresses occupied; and
selecting one or more data sets in an associated storage system for de-duplication based on the derived estimates.
